(19) United States
(12) Patent Application Publication
(10) Pub. No.: US 2014/0245428 A1
(43) Pub. Date: Aug. 28, 2014

(54) COMPUTER AND CONTROL METHOD THEREOF

(71) Applicant: Quanta Computer Inc., Taoyuan Shien (TW)

(72) Inventors: Chi-Li LI, Taoyuan County (TW); Chun-Hao LIEN, Taipei City (TW); Fang-Cing SU, Taoyuan County (TW)

(21) Appl. No.: 13/940,892

(22) Filed: Jul. 12, 2013

(30) Foreign Application Priority Data
Feb. 22, 2013 (TW) 102106257

(51) Int. Cl. H04L 29/06

(52) U.S. Cl. CPC H04L 63/10
USPC 726/16

(57) ABSTRACT

A computer and a control method thereof are disclosed. The computer comprises a processor, a chipset, a near field communication (NFC) module and a coprocessor. The chipset is coupled to the processor. The NFC module reads a current user identification (UID) from the NFC card when the NFC card is close to the NFC module. The coprocessor stores a default UID, and verifies whether the current UID is the same as the default UID. The coprocessor controls the chipset to execute a power-on sequence when the current UID is the same as the default UID.

This application claims the benefit of Taiwan application Serial No. 102106257, filed Feb. 22, 2013, the subject matter of which is incorporated herein by reference.

### BACKGROUND OF THE INVENTION

1. Field of the Invention

The invention relates in general to an electronic apparatus, and more particularly to a computer and a control method thereof.

2. Description of the Related Art

Along with the advance in the information technology, computer has been widely accepted and used. Conventionally, the user manually presses a power button to activate the power-on sequence of a computer. After the power button is pressed, the computer will firstly load in a basic input/output system (BIOS) to execute many functions, such as power-on self-test (POST), hardware detection, driver installation and loading an operating system (OS).

A conventional computer can be booted as long as the power button is manually pressed regardless of the user being legitimate or not. Under such circumstance, information security will be severely jeopardized. Moreover, if verification requires an input of password, the user will not be able to boot the computer if the user forgot the password. Therefore, how to provide operation convenience to the user and at the same time increase information security has become a prominent task for the industries.

### SUMMARY OF THE INVENTION

The invention is directed to a computer and a control method thereof, in which a near field communication (NFC) card is used to control the computer to automatically execute the power on/off sequence, not only providing more operation convenience but also increasing information security.

According to an embodiment of the present invention, a computer is disclosed. The computer comprises a processor, a chipset, a near field communication (NFC) module and a coprocessor. The chipset is coupled to the processor. The NFC module reads a current user identification (UID) from the NFC card when the NFC card is close to the NFC module. The coprocessor stores a default UID, and verifies whether the current UID is the same as the default UID. The coprocessor controls the chipset to execute a power-on sequence when the current UID is the same as the default UID.

According to another embodiment of the present invention, a control method of a computer is disclosed. The computer comprises a chipset, a coprocessor and an NFC module. The coprocessor stores a default UID. The control method comprises: determining whether the NFC card is close to the NFC module; reading a current UID from the NFC card by the NFC module when the NFC card is close to the NFC module; verifying whether the current UID is the same as the default UID; controlling the chipset by the coprocessor to execute a power-on sequence when the current UID is the same as the default UID.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a computer and an NFC card according to a first embodiment of the invention;

FIG. 2 shows a schematic diagram of a coprocessor and an NFC module.

FIG. 3 shows a process of a control method of a computer according to a first embodiment of the invention;

FIG. 4 shows a detailed process of step 303;

FIG. 5 shows a schematic diagram of an operating system, a BIOS and a coprocessor; and

FIG. 6 shows a process of a control method of a computer according to a second embodiment of the invention.

### DETAILED DESCRIPTION OF THE INVENTION

### First Embodiment

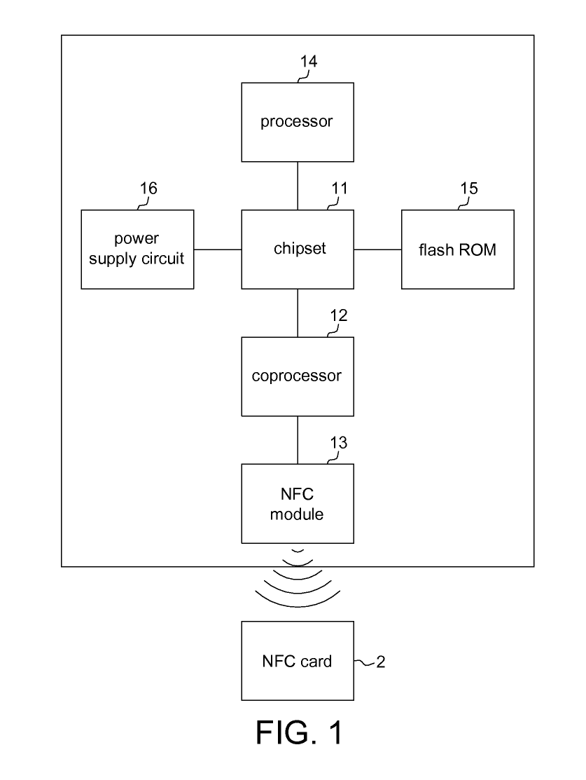

Referring to FIG. 1, a schematic diagram of a computer and an NFC card according to a first embodiment of the invention is shown. The computer 1, such as a desktop computer, a tablet PC, a notebook, an all in one (AIO) or an ultrabook, comprises a chipset 11, a coprocessor 12, a near field communication (NFC) module 13, a processor 14, a flash read only memory (ROM) 15 and a power supply circuit 16. The chipset 11 is coupled to the coprocessor 12, the processor 14, the flash ROM 15 and the power supply circuit 16. The NFC module 13 is coupled to the coprocessor 12. The flash ROM 15 stores a basic input/output system (BIOS) code.

The NFC module 13 reads a current user identification (UID) from the NFC card 2 when the NFC card 2 is close to the NFC module 13. The coprocessor 12, such as an embedded controller (EC), stores a default user identification (UID). The coprocessor 12 verifies whether the current UID is the same as the default UID, and controls the chipset 11 to execute a power-on sequence when the current UID is the same as the default UID. When executing a power-on sequence, the chipset 11 controls the power supply circuit 16 to provide necessary working voltage to the computer 1.

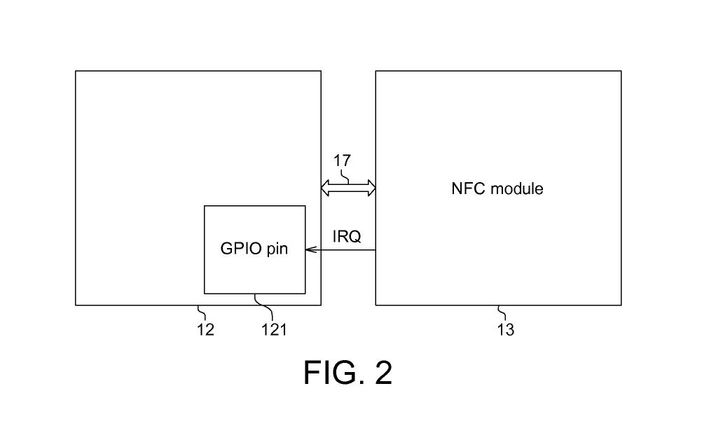

Referring to FIG. 1 and FIG. 2. FIG. 2 shows a schematic diagram of a coprocessor and an NFC module. The coprocessor 12 comprises a general purpose input/output (GPIO) pin 121. The NFC module 13 outputs an interrupt request IRQ to the GPIO pin 121 of the coprocessor 12 when the NFC card 2 is close to the NFC module 13. The coprocessor 12 may communicate with the NFC module 13 through the bus 17, such as a system management bus (SMBus) or an inter-integrated circuit (I2C). The bus 17 may further comprise a clock signal line and a data signal line.

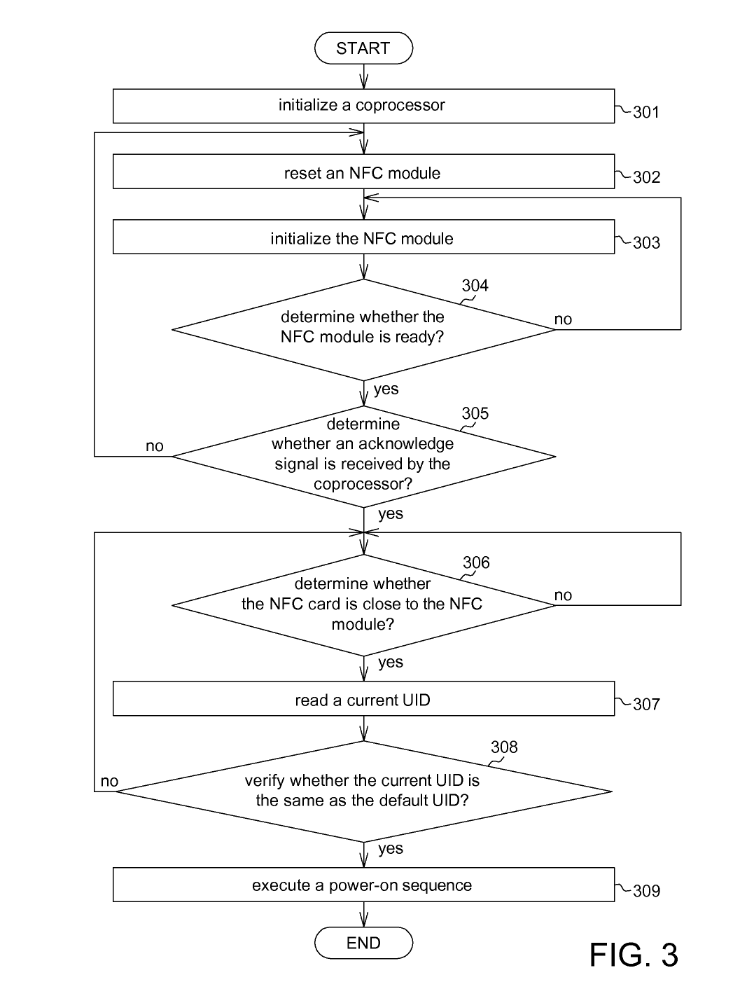

Referring to FIG. 1 and FIG. 3. FIG. 3 shows a process of a control method of a computer according to a first embodiment of the invention. The control method of a computer 1 comprises the following steps: Firstly, the process begins at step 301, the coprocessor 12 is initialized. Next, the process proceeds to step 302, the NFC module 13 is reset. Then, the process proceeds to step 303, the NFC module 13 is initialized. For example, the coprocessor 12 sends a reset command to reset the NFC module 13. Then, the process proceeds to step 304, whether the NFC module 13 is ready is determined by the coprocessor 12. The process proceeds to step 305 if the NFC module 13 is ready, and executes step 303 again if the NFC module 13 is not ready.

In step 305, whether the coprocessor 12 receives an acknowledge signal ACK from the NFC module 13 is determined. The process proceeds to step 306 if the coprocessor 12 receives an acknowledge signal from the NFC module 13, and executes steps 302˜304 again if the coprocessor 12 did not receive any acknowledge signal from the NFC module 13. In step 306, whether the NFC card 2 is close to the NFC module 13 is determined. The proceeds to step 307 if the NFC card 2 is close to the NFC module 13, and executes step 306 again if the NFC card 2 is not close to the NFC module 13. In step 307, a current UID is read from the NFC card 2 by the NFC module 13. Then, the process proceeds to step 308, whether the current UID is the same as a default UID is verified by the coprocessor 12. The process proceeds to step 309 if the current UID is the same as the default UID, and executes steps 306˜308 again if the current UID is not the same as the default UID. In step 309, the chipset 11 is controlled by the coprocessor 12 to execute a power-on sequence

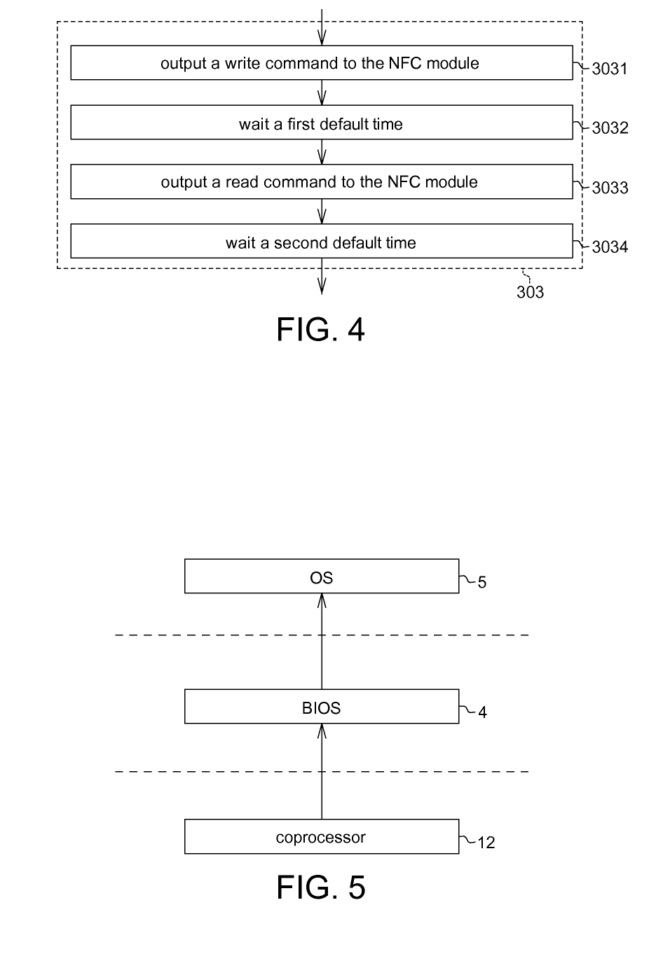

Referring to FIG. 1, FIG. 3 and FIG. 4. FIG. 4 shows a detailed process of step 303. Step 303 further comprises steps 3031˜3034. In step 3031, a write command is outputted to the NFC module 13 by the coprocessor 12. Next, the process proceeds to step 3032, the NFC module 13 waits a first default time to assure that the write command is received by the NFC module 13. Then, the process proceeds to step 3033, a read command is outputted to the NFC module 13 by the coprocessor 12. Then, the process proceeds to step 3034, the NFC module 13 waits a second default time to assure that the read command is received by the NFC module 13. The first default time and the second default time can be adjusted according to the specifications and actual configuration of the computer 1.

### Second Embodiment

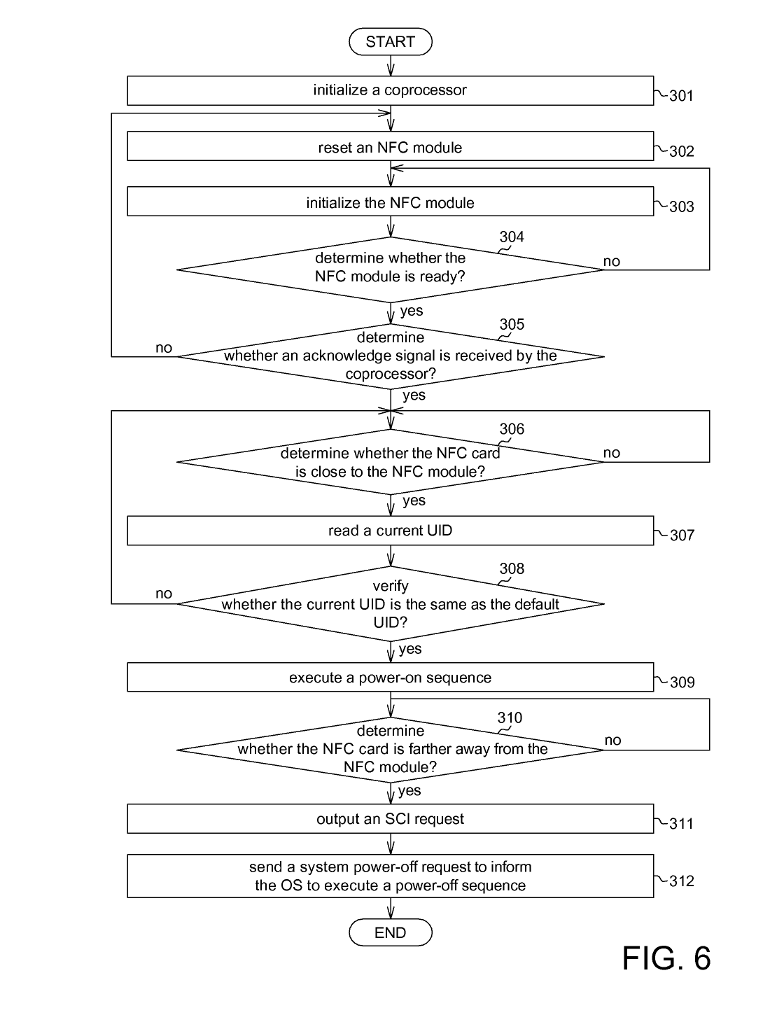

Referring to FIG. 1, FIG. 5 and FIG. 6. FIG. 5 shows a schematic diagram of an operating system, a BIOS and a coprocessor. FIG. 6 shows a process of a control method of a computer according to a second embodiment of the invention. The second embodiment is different from the first embodiment mainly in that the second embodiment further comprises steps 310˜312 in addition to steps 301˜309. In the second embodiment, the process proceeds to step 310 after step 309 is completed. In step 310, whether the NFC card 2 is farther away from the NFC module 13 is determined. The process proceeds to step 311 if the NFC card 2 is farther away from the NFC module 13, and executes step 310 again if the NFC card 2 is not farther away from the NFC module 13. In step 311, a system control interrupt (SCI) request is outputted by the coprocessor 12. Then, the process proceeds to step 312, a system power-off request is sent by the BIOS 4 to inform the operating system 5 to execute a power-off sequence.

The computer and the control method thereof disclosed in above embodiments use an NFC card to control the computer to automatically execute the power on/off sequence, not only providing more operation convenience but also increasing information security.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer, comprising:
a processor;
a chipset coupled to the processor;
a near field communication (NFC) module used for reading a current user identification (UID) from the NFC card when an NFC card is close to the NFC module; and
a coprocessor used for storing a default user identification (UID) and verifying whether the current UID is the same as the default UID, wherein the coprocessor controls the chipset to execute a power-on sequence when the current UID is the same as the default UID.

2. The computer according to claim 1, wherein the NFC module outputs an interrupt request (IRQ) to the coprocessor when the NFC card is close to the NFC module.

3. The computer according to claim 2, wherein the coprocessor comprises a general purpose input/output (GPIO) pin, and the NFC module outputs the interrupt request (IRQ) to the GPIO pin.

4. The computer according to claim 1, wherein if the NFC card is farther away from the NFC module, the coprocessor outputs a system control interrupt (SCI), and a basic input/output system (BIOS) sends a system power-off request to inform an operating system to execute a power-off sequence.

5. The computer according to claim 1, wherein the coprocessor resets the NFC module after the coprocessor is initialized.

6. The computer according to claim 5, wherein the NFC module is initialized after the NFC module is reset.

7. The computer according to claim 6, wherein after the NFC module is initialized, the coprocessor determines whether the NFC module is ready; if the NFC module is ready, then whether the coprocessor receives an acknowledge signal from the NFC module is determined; if the coprocessor receives the acknowledge signal, then the NFC module reads the current UID from the NFC card when the NFC card is close to the NFC module.

8. The control method according to claim 7, wherein when the NFC module is initialized, the coprocessor outputs a write command to the NFC module and waits a first default time, and after the first default time, the coprocessor further outputs a read command to the NFC module and waits a second default time.

9. A control method of a computer, wherein the computer comprises a chipset, a coprocessor and a near field communication (NFC) module, the coprocessor stores a default UID, and the control method comprises:
determining whether an NFC card is close to the NFC module;
reading a current UID from the NFC card by the NFC module when the NFC card is close to the NFC module;
verifying whether the current UID is the same as the default UID; and
controlling the chipset by the coprocessor to execute a power-on sequence when the current UID is the same as the default UID.

10. The control method according to claim 9, wherein the NFC module outputs an interrupt request (IRQ) to the coprocessor when the NFC card is close to the NFC module.

11. The control method according to claim 10, wherein the coprocessor comprises a general purpose input/output (GPIO) pin, and the NFC module outputs the interrupt request (IRQ) to the GPIO pin.

12. The control method according to claim 9, further comprising:
determining whether the NFC card is farther away from the NFC module;
outputting a system control interrupt (SCI) when the NFC card is farther away from the NFC module,; and
sending a system power-off request by a basic input/output system (BIOS) to inform an operating system to execute a power-off sequence.

13. The control method according to claim 9, further comprising:
initializing the coprocessor;
resetting the NFC module; and
initializing the NFC module.

14. The control method according to claim 13, further comprising:
determining whether the NFC module is ready;
determining whether the coprocessor receives an acknowledge signal from the NFC module when the NFC module is ready; and
determining whether the NFC card is close to the NFC module is determined if the coprocessor receives the acknowledge signal.

15. The control method according to claim 13, wherein the step of initializing the NFC module comprises:
outputting a write command to the NFC module;
waiting a first default time;
outputting a read command to the NFC module; and
waiting a second default time.
